(19) United States
(12) Patent Application Publication
(10) Pub. No.: US 2004/0180692 A1
(43) Pub. Date: Sep. 16, 2004

(54) PORTABLE NETWORK TRANSMISSION DEVICE

(75) Inventors: D. Y. Yang, Hsinchu (TW); Por-Horng Lin, Hsinchu (TW); Ying-Tsai Hsu, Hsinchu (TW)

Correspondence Address: CONNOLLY BOVE LODGE & HUTZ LLP, SUITE 800, 1990 M STREET NW, WASHINGTON, DC, 20036-3425, US

(73) Assignee: HANDLINK TECHNOLOGIES INC., Hsinchu (TW)

(21) Appl. No.: 10/604,532

(22) Filed: Jul. 29, 2003

(30) Foreign Application Priority Data
Aug. 1, 2002 (TW) 091211895

(51) Int. Cl. H04M 11/00; H04B 1/38

(52) U.S. Cl. 455/557; 455/558; 455/405

(57) ABSTRACT

A portable network transmission device comprises a computer terminal, a case, and a subscriber identification module. One end of the case is connected to the computer terminal, and the subscriber identification module is configured within the case. The user can plug the computer terminal of the portable network transmission device into the connection port of the computer to be able to access the Internet. Moreover, the portable network transmission device can be connected with a non-volatile memory device for data storage, or with a wireless transmission portion to provide with the wireless network connection capability.

### BACKGROUND OF THE INVENTION

The present invention relates to a portable network transmission device, and more specifically, to a portable network transmission device with Subscriber Identification Module (SIM).

Wireless network technology is becoming widely used, and many enterprises and public buildings, such as international airports, hotels and coffee shops are implementing the technology to provide wireless Internet services to consumers. Users only need to use their own notebook computers or PDAs, and rent the wireless network interface card or subscribe to the service to connect to the wireless network. They can then access the Internet world for e-mail, on-line games, personal financial information, news, etc. Thus, the network resources can be accessed at any time and from any place.

However, the renting of wireless network interface cards is not very convenient, because operating systems like Microsoft Windows do not support the different types of wireless network interface cards from different manufacturers. The first time a network interface card is used, its driver must be installed, and the driver may need to be downloaded from the network, or the user may need to borrow a CD-ROM with the driver from the service counter. It should be specially noted that, wireless network interface cards from different manufacturers or of different models all have their own software drivers, so that it would be necessary to install the proper software driver and proceed with the associated network configuration for Internet access when renting the wireless network interface cards at any place which does not offer the customer plug-and-play capability.

Even if a user is accessing the public network system using wired transmission, he also needs to pre-configure his computer and apply for a password in advance in order to enter the account. In other words, it is not convenient for the user to remember the passwords and account names provided by different service providers at different places. In addition, such a device would be preceded with many types of configurations for first time use, so that it is very clumsy for the users.

The dial-up connection with a mobile phone is another conventional method for wireless network access, which has two types: one is to browse and operate on the display of the mobile phone directly (so called WAP system), but it cannot replace the computer screen due to the small display size and insufficient colors; another is to combine the wireless network interface card with the mobile phone via a double-socket connector, which is mounted on the wireless network interface card in the notebook computer and uses the mobile phone as the communication tool to the dial-up network. Although the latter case can meet the requirements for wireless Internet access from any location, the communication network via a mobile phone still has its own limited frequency and allowable communication range. The communication networks of telecom companies may be roamed with each other, but actually it will cost a lot because of the communication fees to both sides, for example, international roaming. Especially, since different countries use different communication network systems, such as GSM system in Taiwan, PDC system in Japan and D-AMPS system in U.S.A., the mobile phone in use cannot work in another incompatible communication network system, even the so-called international roaming cannot provide an unlimited dial-up Internet accessing function for different countries.

In summary, it has become an important issue in the industry to provide a device with network roaming or billing functions for the users with a simple configuration.

### BRIEF SUMMARY OF THE INVENTION

The main objective of the present invention is to provide a portable network transmission device, which uses a built-in subscriber identification module to provide network roaming or billing functions for the user with a simple configuration.

The second objective of the present invention is to provide a portable network transmission device that is compact. The user can use the computer terminal on the portable network transmission device to connect with a networking device without repetitively loading different configurations, so as to be able to access the Internet rapidly.

The third objective of the present invention is to provide a portable network transmission device, which is provided with a built-in subscriber identification module for prepaid, automatic billing, like a telephone card, deducting from the pre-paid amount, and with similar functions, to make it convenient for the user's payment and the provider's charge.

In order to achieve the objectives and prevent the defects of the conventional techniques, the present invention discloses a portable network transmission device, which comprises a computer terminal, a case, and a subscriber identification module. One end of the case is connected to the computer terminal, and the subscriber identification module is configured within the case.

The user can plug the computer terminal of the portable network transmission device according to the present invention into the connection port of the computer to be able to access the Internet. Moreover, the portable network transmission device according to the present invention can be added with a non-volatile memory device for data storage, or with a wireless transmission portion to provide wireless Internet connection capability.

### BRIEF DESCRIPTION OF THE DRAWINGS

The invention will be described according to the appended drawings in which:

FIG. 1 shows a perspective view of the first embodiment of the portable network transmission device in accordance with the present invention;

FIG. 2 shows a perspective view of the second embodiment of the portable network transmission device in accordance with the present invention;

FIG. 3 shows the practical application of the portable network transmission device connected with a computer in accordance with the present invention;

FIG. 4 shows a perspective view for the third embodiment of the portable network transmission device in accordance with the present invention;

FIG. 5 shows a perspective view for the fourth embodiment of the portable network transmission device in accordance with the present invention;

FIG. 6 shows the practical application of the portable network transmission device connected with a notebook computer in accordance with the present invention;

FIG. 7 shows the practical application of the portable network transmission device connected with a notebook computer in accordance with the present invention; and

FIG. 8 shows the wireless Internet access of a preferred embodiment in accordance with the present invention.

### DETAILED DESCRIPTION OF THE INVENTION

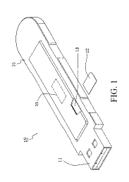

FIG. 1 shows a perspective view of the first embodiment of the portable network transmission device in accordance with the present invention. The portable network transmission device 10 is provided with a USB terminal 11, which is used to connect with the USB port on a computer. Of course, the USB terminal 11 can be replaced with other terminal types, like IEEE 1394, PCMCIA and any type of terminal for electric signal communication with the computer that is within the scope of the present invention. The portable network transmission device 10 according to the present invention further comprises a case 15, which may be PCMCIA card, CF (Compact Flash) memory card, SD (Secure Digital) memory card, memory stick memory card, or any other kind of portable insertion cards. The portable network transmission device 10 further comprises a subscriber identification module 12, which can provide the network roaming or billing functions for the user with a simple configuration. The subscriber identification module 12 can be directly fixed within the case, or the case may be designed with an insertion hole 13 on the top of the case 15 or on the side. The user may purchase the subscriber identification module 12 provided or sold by the local network company in the country or region he is located in, and insert the module into the insertion hole 13 without repetitively loading the configurations so as to allow the rapid Internet access. Moreover, the subscriber identification module 12 can be added with an Internet access pre-paid card or other billing functions for easy use by the user. Furthermore, in connection with the storage of personalized data, the portable network transmission device 10 may comprise a non-volatile memory 14, such as flash memory, electrically erasable memory, and the like.

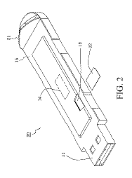

FIG. 2 shows a perspective view of the second embodiment of the portable network transmission device in accordance with the present invention. The second embodiment is different from the first embodiment in FIG. 1 by the addition of a wireless transmission portion 21, so that the user can directly use the portable network transmission device 20 according to the present invention to employ wireless LAN, Bluetooth, or other wireless transmission methods to communicate with remote wireless transmission devices.

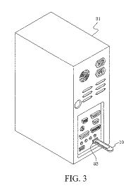

As described above, the portable network transmission device 10 according to the present invention may use a USB terminal 11 to connect with the USB port 32 of a computer 31 for communicating the electric signals with the computer 31. FIG. 3 is a diagram for such an application.

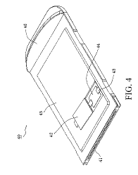

FIG. 4 shows a perspective view for the third embodiment of the portable network transmission device in accordance with the present invention. The third embodiment is different from the first embodiment in FIG. 1 by using a PCMCIA terminal 41 in place of the USB terminal in the first embodiment, thus it is suitable for the PCMCIA port on a notebook computer. Moreover, the portable network transmission device 40 is provided with a shutter window 42 on the top of the case 45 for the portable network transmission device 40, so that the user may purchase the subscriber identification module 44 that is provided or sold by the local network company in the country or region he is located, and put it directly into the shutter window 42 and fix it with a clip or a clamp 43. With this subscriber identification module 44, the user does not need to repetitively load the configurations and may have rapid Internet access. Furthermore, the portable network transmission device 40 is also provided with a wireless transmission portion 46, so that the user can directly use the wireless LAN, Bluetooth or other wireless transmission method to communicate with remote wireless transmission devices.

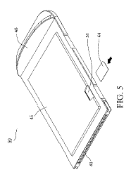

FIG. 5 shows a perspective view for the fourth embodiment of the portable network transmission device in accordance with the present invention. The fourth embodiment is different from the third embodiment in FIG. 4 in that there is an insertion hole 51 on the side of a case in place of the shutter window 42 in the third embodiment. Because the subscriber identification module 44 is inserted into the portable network transmission device 50 from the side, it will be more convenient for some users.

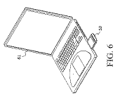

Referring to FIG. 6, the portable network transmission device 50 according to the present invention can use a PCMCIA terminal 41 to connect with the PCMCIA port on a notebook computer 61 for communicating electrical signals to the notebook computer 61. Moreover, because the portable network transmission device 50 already has a wireless transmission portion 46, the user can communicate with remote wireless transmission devices without the addition of any other devices.

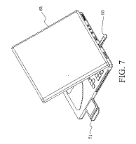

FIG. 7 is a diagram for the application of the portable network transmission device according to the present invention. The portable network transmission device 10 according to the present invention can use a USB terminal 11 to connect with the USB port on a notebook computer 61 for communicating electrical signals with the notebook computer 61. In addition, by mounting a wireless network interface card 71 on the notebook computer 61, the user can communicate with remote wireless transmission devices.

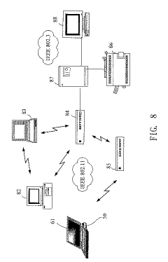

FIG. 8 is a diagram for wireless Internet access of a preferred embodiment according to the present invention. The portable network transmission device 50 according to the present invention is inserted into the PCMCIA dock on the notebook computer 61, and the portable network transmission device 50 will be instructed by the driver software in the computer to execute the account connecting operations for wireless Internet access. If the account is of the pre-paid type, it is very suitable for the nonresident user. When the connection signal is sent from the wireless transmission portion 46, the adjoining access point 85 will receive the signal. The protocol in the transmission process uses the standard IEEE 802.11/802.11b, and the like. Generally, if the transmission speed is 11 Mbps, the communication distance will be about 30 meters; and, if the transmission speed is 1 Mbps, the communication distance will be about 90 meters. Recently, some of the manufacturers (like 3Com, U.S.A) can provide transmission speed at 11 Mbps with the communication distance up to about 90 meters. The access point 85 may connect with another access point 86 via wireless transmission, where the user can exchange the information with a remote computer 82 or a portable computer 83 using the same wireless access method. The access point 85 also can be directly or indirectly connected to a wired LAN or backbone network for accessing more fruitful network information. For example, the user may access the resource in a network server 87 through the IEEE 802.3 communication protocol, exchange the information with a network-monitoring computer 88 through the network server 87, or print out the data through a printer 86.

The above-described embodiments of the present invention are intended to be illustrative only. Numerous alternative embodiments may be devised by persons skilled in the art without departing from the scope of the following claims.

1. A portable network transmission device, comprising:
a computer terminal;
a case, one end of the case connected to the computer terminal; and
a subscriber identification module configured within the case;
whereby the subscriber identification module is used to provide network roaming or billing functions for a user with a simple configuration.

2. The portable network transmission device of claim 1, wherein the case has an opening capable of inserting the subscriber identification module.

3. The portable network transmission device of claim 2, wherein the opening is a shutter window placed on the top of the case.

4. The portable network transmission device of claim 2, wherein the opening is an insertion hole placed on one side of the case.

5. The portable network transmission device of claim 1, wherein the subscriber identification module is embedded inside the case.

6. The portable network transmission device of claim 1, wherein a wireless transmission portion is placed on one side of the case opposite to the computer terminal.

7. The portable network transmission device of claim 1, wherein the device further comprises a non-volatile memory in the case.

8. The portable network transmission device of claim 1, wherein the case is a PCMCIA card, a CF memory card, a SD memory or a memory stick card.

9. The portable network transmission device of claim 1, wherein the computer terminal is a USB port, an IEEE 1394 port or a PCMCIA port.

10. The portable network transmission device of claim 6, wherein the wireless transmission portion is a wireless LAN module or a Bluetooth module.

11. The portable network transmission device of claim 1, wherein the subscriber identification module is capable of pre-paying Internet access.
